(19) United States
(12) Patent Application Publication
(10) Pub. No.: US 2015/0128521 A1
(43) Pub. Date: May 14, 2015

(54) LEAF PROFILE FOR A WINDOW, A WINDOW AND METHOD FOR INSTALLING A WINDOW

(71) Applicant: REYNAERS ALUMINIUM, NAAMLOZE VENNOOTSCHAP, Duffel (BE)

(72) Inventors: Stefan Vandervelden, Berchem (BE); Veronique Vloemans, Oelegem (BE)

(21) Appl. No.: 14/395,215

(22) PCT Filed: Apr. 16, 2013
(86) PCT No.: PCT/BE2013/000018

§ 371 Date: Oct. 17, 2014

(30) Foreign Application Priority Data
Apr. 20, 2012 (BE) 2012/0260

(51) Int. Cl. E06B 1/34; E04F 19/06; E06B 1/36; E04F 19/02

(52) U.S. Cl. CPC E06B 1/342; E04F 19/02; E04F 19/06; E06B 1/36
USPC 52/656.5; 52/745.16

(57) ABSTRACT

Covering element (7) to cover the edge of a glass pane (5), characterised in that the covering element (7) includes a leaf profile (6) for a leaf (3,4) of a window (1) or door and includes at least one adjustable setting piece (10), whereby the setting piece (10) is or can be fastened to an edge of the glass pane (5), whereby the leaf profile (6) is or can be connected to the setting piece (10), and whereby the setting piece (10) is arranged to be able to adjust the distance between the leaf profile (6) and the edge of the glass pane (5) when using the covering element (7).

The present invention relates to a leaf profile for a window, a window and a method for installing a window.

More specifically, the invention concerns windows whereby a leaf of a window has a leaf profile along all or part of its edges that is fastened to the edge of a glass pane, for example by gluing.

This can for example, but not exclusively, be ‘minimum profile windows’ in which the leaves are manufactured from very thin profiles that are essentially hidden from view because they are behind an outer frame placed in the wall. These leaf profiles are normally glued to the edge of the glass pane that also forms part of the leaf.

However, a problem arises here relating to the accommodation of tolerances. An outer frame of a window is made to a certain size, and then installed in a wall. The glass pane or the glass panes of a window is or are made to a certain size beforehand.

In practice both the frame and the glass panes may deviate from a specified target size by a few millimetres or more due to their production. There can also be differences relating to the formation of a perfect rectangle.

With non-glued leaf profiles, the differences are traditionally accommodated by pinning the glass in the leaves. However, this is not possible when the leaf profile and the glass are glued, and thus when the leaf profile is supported by the glass pane instead of the other way around as with conventional leaves.

The purpose of the present invention is to provide a solution to a least one of the aforementioned and other disadvantages by providing a covering element to cover the edge of a glass pane, whereby the covering element comprises a leaf profile of a leaf of a window or door and comprises at least one adjustable setting piece, whereby the setting piece is or can be fastened to an edge of the glass pane, whereby the leaf profile is or can be connected to the setting piece, and whereby the setting piece is arranged to be able to adjust the distance between the leaf profile and the edge of the glass pane when using the covering element.

As specified above, it concerns a leaf profile that is supported by a glass pane, that thus does not form part of a frame that supports and surrounds the glass pane.

In other words, the leaf profile is freely adjustable with respect to the glass pane without restrictions that are caused by it being fastened to other leaf profiles that are fastened to the glass pane.

In this way the setting piece can be fastened to the glass pane while the positioning of the leaf profile with respect to the setting piece can be adjusted for the purpose of compensating for the manufacturing tolerances of the glass pane and a frame of the window.

To this end preferably a few setting pieces are provided along each edge of the glass pane along which a leaf profile has to be affixed, so that an accurate adjustment can be obtained.

Preferably the setting piece comprises a first part that is arranged to be mounted on the glass pane and a second part that is arranged to keep the leaf profile at a set minimum distance from the first part, whereby preferably the second part is adjustably fastened by means of a screw thread in the first part.

This is a practical embodiment of the setting piece.

In a preferred embodiment the leaf profile can be fastened to the first part of the setting piece and not, or only indirectly, to the second part of the setting piece.

In this way a good direct connection between the glass pane and the leaf profile is created that cannot vary over time due to variations of the setting of the setting piece.

In a further preferred embodiment the covering element also comprises a connecting profile that is intended to be fastened to an edge of a glass pane, whereby the connecting profile and the setting piece are arranged such that the setting piece is or can be fastened to an edge of the glass pane by means of the connecting profile.

In a further preferred embodiment the leaf profile is provided with an opening along which the second part of the setting piece can be driven.

As a result the setting piece can be driven more easily.

In a further preferred embodiment the first part of the setting piece is provided with two folded-over protruding ridges extending on either side that each define an L-shaped groove, and is provided with a first, second and third screw hole that is perpendicular to the direction in which the grooves extend, whereby the second part of the setting piece is a bolt or screw that fits in the second screw hole that is provided with a driving recess on the side turned away from the grooves.

This is a practical embodiment to manufacture such a setting piece.

The driving recess is a recess that is intended to enable the screw or bolt to be turned by means of a complementary tool, for example a straight slot, cross slot, socket or star.

The setting piece can be made from various different materials, whereby metal and high quality plastic are the most obvious.

The invention also relates to a setting piece for use in a covering element as described above and a window that comprises a glass pane and a covering element as described above, whereby the setting piece is fastened to the edge of the glass pane by means of the connecting profile if present.

Furthermore the invention concerns a method for installing a window that comprises an outer frame and at least one glass pane, whereby a leaf profile is affixed at an edge of the glass pane, whereby an adjustable setting piece is fastened directly or indirectly to the glass pane, whereby the leaf profile is fastened to the glass pane by means of the setting piece, whereby the distance between the edge of the glass pane and the leaf profile is adjusted by means of the setting piece.

The invention also concerns the use of an adjustable setting piece that is fastened to a glass pane in order to mount a leaf profile at a specific distance from an edge of the glass pane.

With the intention of better showing the characteristics of the invention, a preferred embodiment of a window with a leaf profile according to the invention is described hereinafter by way of an example, without any limiting nature, with reference to the accompanying drawings, wherein:

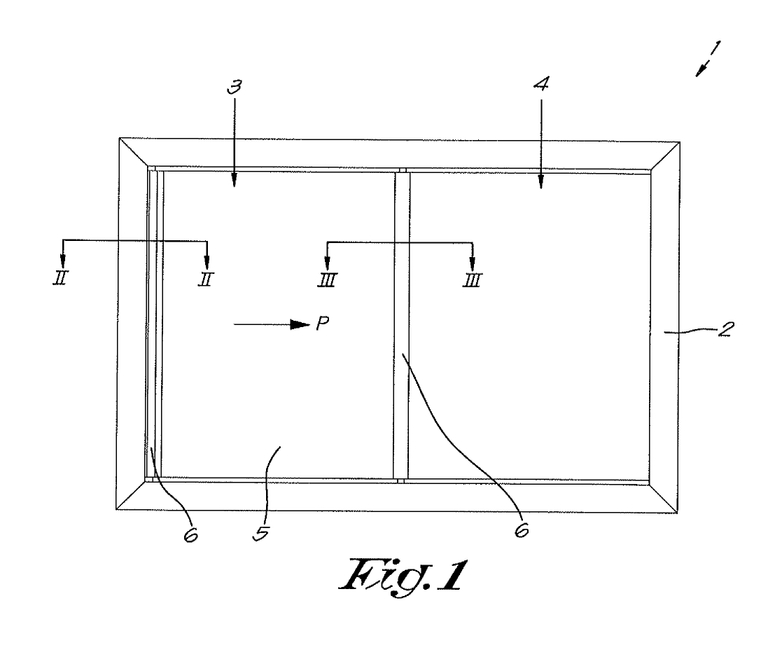

FIG. 1 schematically shows a window according to the invention;

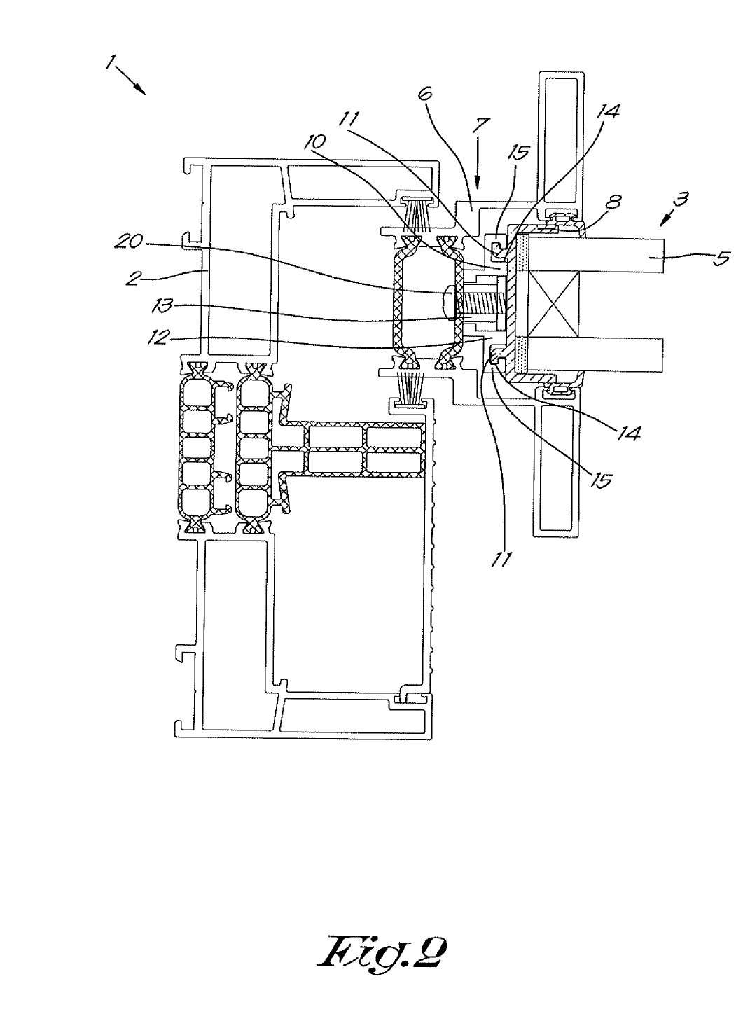

FIG. 2 shows a cross-section according to line II-II through the window of FIG. 1;

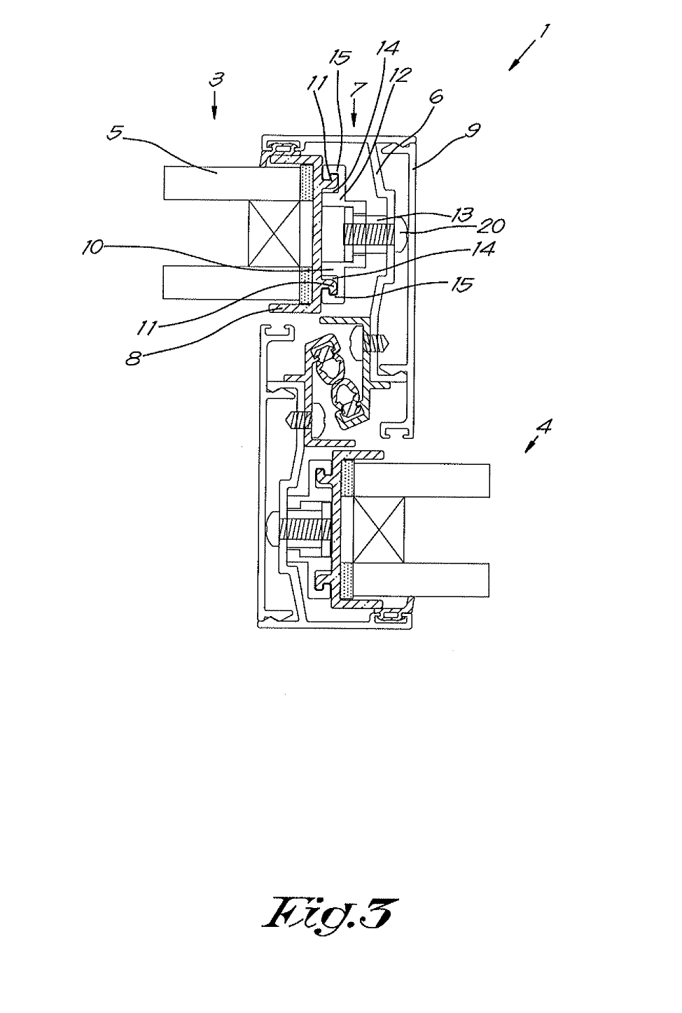

FIG. 3 shows a cross-section according to line III-III through the window of FIG. 1;

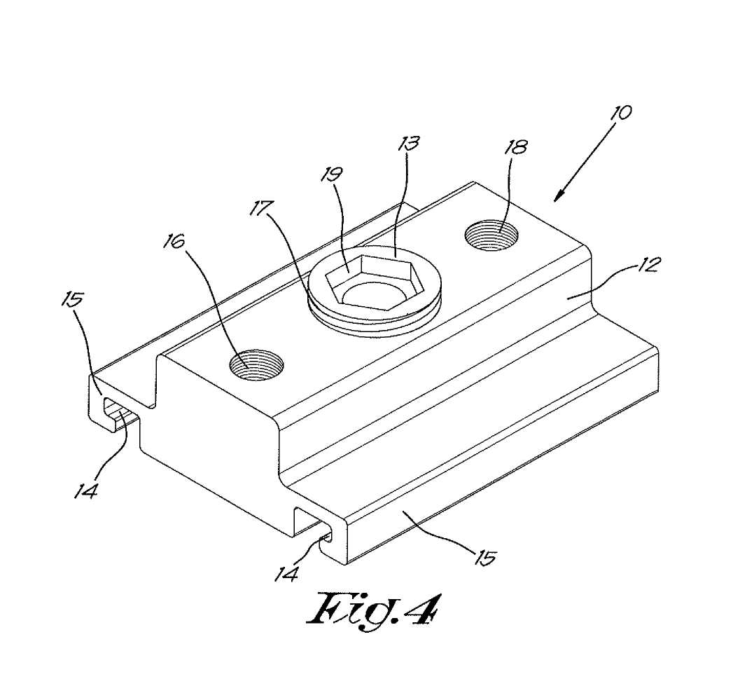

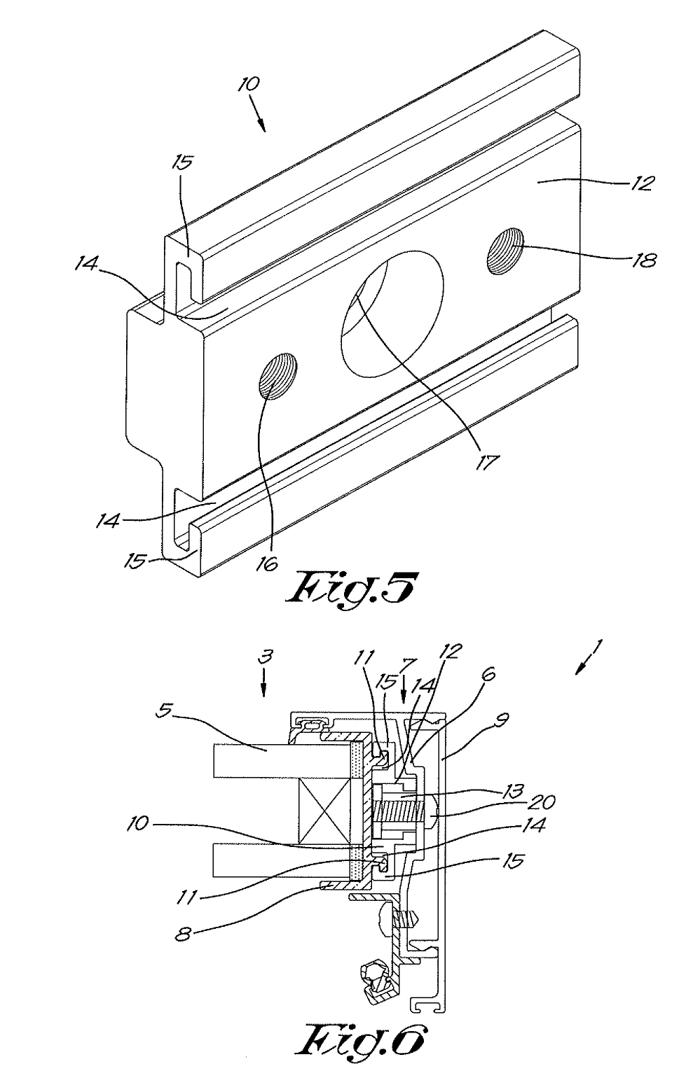

FIGS. 4 and 5 show a component of a window according to FIG. 1 in detail in two different views; and

FIG. 6 shows a part of the cross-section of FIG. 3 in an alternative usage state.

The window 1 shown in FIGS. 1 to 3 is a sliding window and essentially consists of a frame 2 and two leaves 3 and 4 affixed in the frame 2, more specifically a slidable leaf that can be slid in the direction of the arrow P and a non-slidable leaf 4.

The leaves 3,4 essentially consist of a glass pane 5 that is provided on one or more of its edges with a leaf profile 6. The leaf profile 6 forms part of a covering element 7 that further comprises a connecting profile 8 and a covering profile 9 that are practically parallel to one another. The covering element also comprises a number of setting pieces 10, for example three of four.

The covering profile 9 is snapped onto the leaf profile 6 by means of a snap connection. On the side of the connecting profile 8 turned away from the glass pane 5 there are two L-shaped teeth 11 in the longitudinal direction of the connecting profile 8.

The connecting profile 8 fits over an edge of the glass pane 5 and is glued to it. The connecting profile 8 and the leaf profile 6 are fastened together by means of the setting pieces 10, that are affixed spread over the length of the edge concerned of the glass pane 5.

A separate setting piece 10 is shown in FIGS. 4 and 5. This consists of a first part 12 and a second part 13.

In this example, but not necessarily, the first part 12 is an aluminium body that is provided with two parallel grooves 14, with a form that is complementary to the teeth 11, and which is formed by folded-over ridges 15 on the body. The first part 12 is provided with three holes with a screw thread that go completely through the first part 12, i.e. a first screw hole 16, a second screw hole 17 and a third screw hole 18.

The second part 13 of the setting piece 10 is formed by a bolt with a socket 19.

The setting pieces 10 are mounted on the connecting profile 8 by placing the teeth 11 in the grooves 14, and by affixing a pressure screw (not shown) in the first screw hole 16. This pressure screw is turned such that it pushes against the connecting profile 8, and thereby secures the teeth 11 in the grooves 14.

The leaf profile 8 is mounted on the setting pieces 11 by means of a bolt 20 that fits in the third screw hole 18 that is turned until the leaf profile 6 rests against the second part 13 of the setting pieces 10.

In order to gain access to the socket 19 of the second part 13, the leaf profile 8 is provided with holes at the places where the second part 13 of the setting pieces 10 are located.

The use of the covering element according to the invention during the assembly of the window 1 is as follows.

At the places where leaf profiles 6 are desired, connecting profiles 8 are glued over the edge of the glass panes 5. The setting pieces 10 and the leaf profiles 6 are then affixed.

The covering elements 7 can also be affixed in a pre-assembled state over the edge of the glass panes 5.

The frame 2 and the wings 3,4 are fitted in the traditional way. The covering elements are then adjusted by loosening the bolts 20, via the holes provided in the leaf profile 6, and turning the second parts 13 of the setting pieces 10 further in or out of the first parts 12 of the setting pieces 10, and when the adjustment is as desired, the bolts 20 are tightened again. Then the covering profile 9 is snapped in its place in order to conceal the holes for accessing the sockets 19 and the bolts 20 from view.

FIG. 6 shows a situation in which the leaf profile 6 is fastened as closely as possible to the glass pane 5, which means that the second part 13 of the setting piece 10 is screwed into the first part 12 to a maximum.

The opposite situation is shown in FIG. 3. All intermediate situations, thus intermediate distances between the leaf profile 6 and the glass pane 5 are also possible.

As part of the function of the covering element 7 consists of compensating for manufacturing differences, not all setting pieces 10 have the same position at an edge of a leaf 3, 4.

During adjustment the following considerations are made: in the closed position of the window 2 this window 2 must be properly closable. The visible parts of the leaf profiles 6 must also run parallel to the sides of the frame 2 and one another.

Preferably the leaf profiles 6 also have to be precisely behind one another at the places where two leaves 3,4 connect together, in a view perpendicular to the glass panes 5, so that the complete leaf profiles 6 appear narrower.

Although in the above example the setting pieces are fastened to the glass pane via a connecting profile, it is also possible within the scope of the invention to fasten the setting pieces to a glass pane in another way, such as for example by directly gluing the setting pieces to the glass pane, or by a clamping mechanism that forms part of or is connected to the setting pieces.

Although a setting piece with a first part and one, centrally placed, second part is described above, the setting piece can also be constructed with a second part that is not on the central axis, thus not in line with the first and third screw hole.

The setting piece can also be constructed with two or more second parts that do not necessarily have to be on the central axis.

This has the advantage that the leaf profile can be somewhat rotated locally or entirely around an axis, defined by the edge of the glass pane, before being secured. In this way any mutual differences in the size of the glass plates, which together form a multilayered glass pane, are compensated for.

The present invention is by no means limited to the embodiment described as an example and shown in the drawings, but a covering element, setting piece and window according to the invention can be realised in all kinds of variants, without departing from the scope of the invention.

1-18. (canceled)

19. Covering element (7) to cover the edge of a glass pane (5), characterised in that the covering element (7) comprises a leaf profile (6) for a leaf (3,4) of a window (1) or door and comprises at least one adjustable setting piece (10), whereby the setting piece (10) is fastened or fastenable to an edge of the glass pane (5), whereby the leaf profile (6) is connected or connectable to the setting piece (10), whereby the setting piece (10) is arranged, when the covering element (7) is in use, to allow adjustment of the distance between the leaf profile (6) and the edge of the glass pane (5), whereby the setting piece (10) comprises a first part (12) that is arranged to be fastened to the glass pane (5) and a second part (13) that is arranged to keep the leaf profile (6) at a set minimum distance from the first part (12) and wherein the covering element (7) also comprises a connecting profile (8) that is intended to be fastened to an edge of a glass pane (5), whereby the connecting profile (8) and the setting piece (10) are arranged such that the setting piece (10) is or can be fastened to an edge of the glass pane (5) by means of the connecting profile (8).

20. Covering element according to claim 19, characterised in that the leaf profile (6) does not form part of a frame that supports and surrounds the glass pane (5).

21. Covering element according to claim 19, characterised in that the second part (13) is provided with an external screw thread and the first part (12) is provided with a complementary internal screw thread.

22. Covering element according to claim 19, characterised in that the second part (13) is adjustably fastened by means of a screw thread in the first part (12).

23. Covering element according to claim 19, characterised in that the leaf profile (6) is fastenable to the first part (12) of the setting piece (10) and not, or only indirectly, to the second part (13) of the setting piece (10).

24. Covering element according to claim 19, characterised in that the first part (12) of the setting piece (10) is arranged to be mounted on the connecting profile (8) because this connecting profile (8) is provided with teeth (11) with a widened head and the first part (12) of the setting piece (10) is provided with undercut grooves (14) that are complementary to the teeth (11).

25. Covering element according to claim 24, characterised in that the setting piece (10) is connectable to the connecting profile (8) by a pressure screw that pushes against the connecting profile (8) and thereby fastens the setting piece (10) against the head of the teeth (11).

26. Covering element according to claim 19, characterised in that the leaf profile (6) is provided with an opening along which the second part (13) of the setting piece (10) can be driven.

27. Covering element according to claim 26, characterised in that it comprises a covering profile (9) to cover the opening.

28. Covering element according to claim 19, characterised in that the first part (12) of the setting piece (10) is provided with two bent protruding ridges (15) extending on either side that each define an L-shaped groove (14), and is provided with a first screw hole (16), a second screw hole (17) and a third screw hole (18), that are perpendicular to the direction in which the grooves (14) extend, whereby the second part (13) of the setting piece (10) is a bolt or screw that fits in the second screw hole (17) that is provided with a driving recess (19) on the side turned away from the grooves (14).

29. Setting piece (10) for use in a covering element (7) according to claim 19.

30. Window (1) that comprises a glass pane (5) and a covering element (7) according to claim 19, whereby the setting piece (10) is fastened to the edge of the glass pane (5) by means of the connecting profile (8).

31. Window according to claim 30, characterised in that the covering element (7) comprises a connecting profile (8) that is fastened to the edge of the glass pane (5) and glued thereto.

32. Method for installing a window (1) that comprises a frame (2) and at least one glass pane (5), whereby a leaf profile (6) is affixed to an edge of the glass pane (5), characterised in that an adjustable setting piece (10) is fastened indirectly to the glass pane (5) by means of a connecting profile (8), and that the leaf profile (6) is fastened to the glass pane (5) by means of the setting piece (10), whereby the distance between the edge of the glass pane (5) and the leaf profile (6) is adjusted by means of the setting piece (10).

33. Covering element according to claim 20, characterised in that the second part (13) is provided with an external screw thread and the first part (12) is provided with a complementary internal screw thread.
